(19) United States
(12) Patent Application Publication
(10) Pub. No.: US 2004/0247921 A1
(43) Pub. Date: Dec. 9, 2004

(54) Etched dielectric film in hard disk drives

(76) Inventors: Robert S. Dodsworth, Austin, TX (US); Guoping Mao, Woodbury, MN (US); Vicki L. Richmond, Austin, TX (US); Rui Yang, Austin, TX (US)

Correspondence Address: 3M INNOVATIVE PROPERTIES COMPANY, PO BOX 33427, ST. PAUL, MN, 55133-3427, US

(21) Appl. No.: 10/784,860

(22) Filed: Feb. 23, 2004

Related U.S. Application Data
(63) Continuation-in-part of application No. 10/235,465, filed on Sep. 5, 2002.
Application No. 10/235,465 is a continuation-in-part of application No. 09/947,082, filed on Sep. 4, 2001.
Application No. 09/947,082 is a continuation-in-part of application No. 09/618,753, filed on Jul. 18, 2000, now Pat. No. 6,403,211.

(51) Int. Cl. B32B 15/08

(52) U.S. Cl. 428/544

(57) ABSTRACT

An etched dielectric film for use in a hard disk drive. The dielectric film has a thickness of about 25 μm or greater when it is attached to a supporting metal substrate, and is subsequently etched to a thickness of about 20 μm or less.

This application is a continuation-in-part application of (1) U.S. patent application Ser. No. 10/235,465, now pending, filed Sep. 15, 2002 and (2) U.S. patent application Ser. No. 10/093,119, now pending, filed Mar. 7, 2002 which is a continuation-in-part of U.S. patent application Ser. No. 09/947,082, now pending, filed Sep. 4, 2001 which is a continuation-in-part of patent application Ser. No. 09/618,753, filed Jul. 18, 2000, now issued as U.S. Pat. No. 6,403,211, all of which are hereby incorporated by reference.

### FIELD

The invention relates to dielectric films useful in hard disk drives.

### BACKGROUND

An etched copper or printed polymer pattern on a polymer film base may be referred to as a flexible circuit or flexible printed wiring. Originally designed to replace bulky wiring harnesses, flexible circuitry is often the only solution for the miniaturization and movement needed for current, cutting-edge electronic assemblies. Thin, lightweight and ideal for complicated devices, flexible circuit design solutions range from single-sided conductive paths to complex, multilayer three-dimensional packages.

Flexible circuits are also used in hard disk drives. Modern computers require media in which digital data can be quickly stored and retrieved. Magnetizable (hard) layers on disks have proven to be a reliable media for fast and accurate data storage and retrieval. Disk drives that read data from and write data to hard disks have become popular components of computer systems. To access memory locations on a disk, a read/write head (also referred to as a “slider”) is positioned slightly above the surface of the disk while the disk rotates beneath the read/write head at an essentially constant velocity. By moving the read/write head radially over the rotating disk, all memory locations on the disk can be accessed. The read/write head is typically referred to as a “flying” head because it includes a slider aerodynamically configured to hover above the surface on an air bearing located between the disk and the slider that is formed as the disk rotates at high speeds. The air bearing supports the read/write head above the disk surface at a height referred to as the “flying height.” A flexible circuit provides connection to the magnetic head carried by the slider of a disk drive suspension assembly. This overcomes difficulties of connecting disk drive circuitry to small magneto-resistive (MR) recording heads.

### SUMMARY OF THE INVENTION

One aspect of the present invention provides an article comprising: a flexure assembly of a hard disk drive comprising a metal substrate and a dielectric film attached to said metal substrate, said dielectric film comprising a polymer selected from the group consisting of polyimides, liquid crystal polymers, and polycarbonates, wherein said dielectric film has been etched to a thickness of less than about 20 μm from an original thickness of about 25 μm or greater.

Another aspect of the present invention provides a method comprising: providing a metal substrate, attaching a dielectric film to said metal substrate, said dielectric film comprising a polymer selected from the group consisting of polyimides, liquid crystal polymers, and polycarbonates, said film having a thickness of about 25 μm or greater, etching said dielectric film to a thickness of less than about 20 μm.

Unless otherwise stated, concentrations of components are presented herein in terms of wt %.

### BRIEF DESCRIPTION OF THE DRAWINGS

FIG. 1 illustrates a flexure for a head gimbal assembly of a hard disk drive.

FIGS. 2a-2m illustrate steps, including a method of the present invention, for making a flexure structure for a hard disk drive.

### DETAILED DESCRIPTION

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

Hard Disk Drives (HDD) and Flexures

Starting materials for making integrated hard disk drive flexures typically comprise a supporting metal layer having a cast (i.e., solvent-coated) dielectric layer or a metal support layer and a thick dielectric layer adhesively bonded together. While casting a film can provide a quick method of obtaining a thin film having a particular desired thickness, these types of film also have disadvantages. Cast films can be difficult to etch, which can make patterning of the dielectric film difficult. To the contrary, aspects of the present invention allow for the selection and use of dielectric films (and adhesives, if applicable) that are readily etchable.

Flexible circuits typically use dielectric substrate materials that are more than 25 μm thick. Automated handling and processing of films less than 50 μm thick is known to be difficult and, therefore, not cost effective. Flexible circuits such as flex-on-suspension circuits for hard disk drive devices can provide improved device performance if the flexible dielectric substrate is thinner than 25 μm. As taught herein, dielectric substrates can be etched uniformly to provide a thinned dielectric layer. In some embodiments, additional thinning of only selected regions or features of the substrate may be useful. For example, chemical etching to form blind holes in flexible circuit substrates can be advantageous because it allows the formation of unsupported or cantilevered lead structures, which cannot be produced by conventional physical methods.

The flexure of a head suspension assembly (HSA) represents a structural element of a hard disk drive that may be fabricated using a multilayer composite. A flexure, as described in U.S. Pat. Nos. 5,701,218 and 5,956,212, comprises a layer of stainless steel for mechanical strength, a polyimide layer for electrical insulation and a ductile copper layer for electrical transmission.

Suspension flexures must be made using very uniform materials, which can be customized to have small but very uniform features. Because the degree of stiffness is critical to performance of the flexure, the material thicknesses are very critical. The need for increased data density requires the read/write head to fly lower. Typical heads at 60-90 GB/sq in data capacity are currently required to fly at less than 10 nm above the rotating media. This requires that the absolute stiffness of the flexure be reduced. Decreasing the thickness of the dielectric layer and lowering the weight of the composite allows construction of flexures having improved flexibility.

The flexure base material is typically stainless steel foil, rolled and tempered to produce a fine, uniform grain structure and to at least a ½ hard condition. It preferably has a very uniform thickness in the range of 12-25 um. The steel surface is typically etched to produce a fine regular texture of 0.1-0.5 um RMS. A commonly used stainless steel material is non-magnetic A.I.S.I. (American Iron and Steel Institute) 302 or 304 grade steel, having a thickness of 25 μm (10 mil), such as Type 304H-TA MW made by Nippon Steel, Tokyo, Japan, for HDD applications.

A flexure may be produced starting with a composite laminate having a layer of stainless steel for mechanical strength, and a dielectric polymer layer to provide an electrically insulating carrier for conductive traces formed on the surface of the dielectric polymer film by either additive plating techniques or subtractive processing. Either method produces the circuit pattern needed for interconnection of a magneto-resistive (MR) read-write head to a hard disk drive.

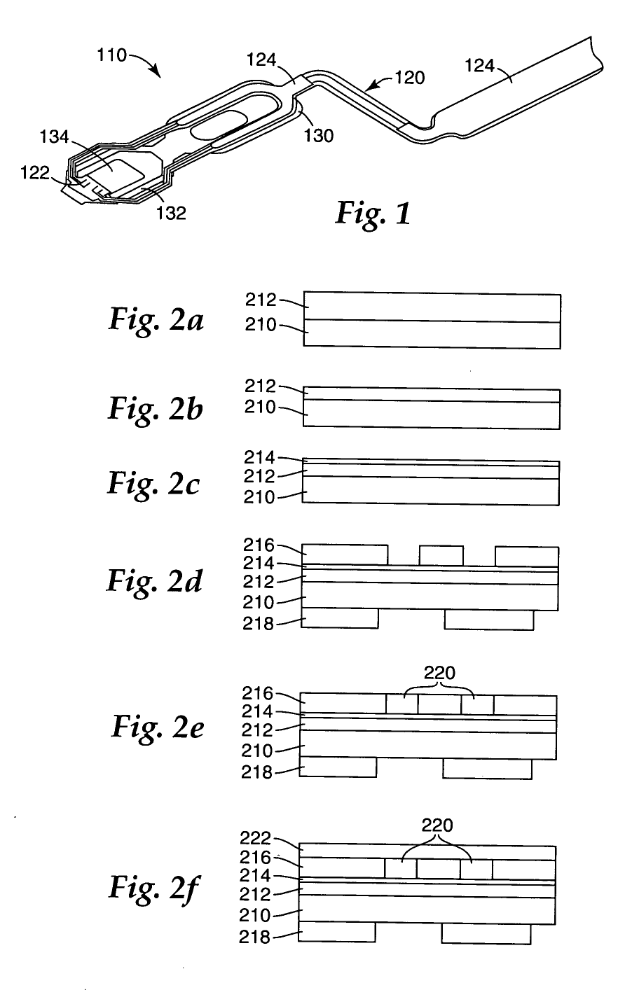

FIG. 1 illustrates a flexure 110 made according to the present invention. Flexure 110 comprises a flexible circuit interconnect 120, which supports metal trace layers 122 and is bonded to metal support structure 130. Gimble arms 132 and tongue 134 are also portions of metal support layer 130. Covercoat polymer 124 protects portions of flexible circuit interconnect 120.

Etchant

The highly alkaline developing solution, referred to herein as an etchant, comprises an alkali metal salt and optionally a solubilizer. A solution of an alkali metal salt alone may be used as an etchant for polyimide but has a low etching rate when etching LCP and polycarbonate. However, when a solubilizer is combined with the alkali metal salt etchant, it can be used to effectively etch polyimide copolymers having carboxylic ester units in the polymeric backbone, LCPs, and polycarbonates.

Water soluble salts suitable for use in the present invention include, for example, potassium hydroxide (KOH), sodium hydroxide (NaOH), substituted ammonium hydroxides, such as tetramethylammonium hydroxide and ammonium hydroxide or mixtures thereof. Useful alkaline etchants include aqueous solutions of alkali metal salts including alkali metal hydroxides, particularly potassium hydroxide, and their mixtures with amines, as described in U.S. Pat. Nos. 6,611,046 B1 and 6,403,211 B1. Useful concentrations of the etchant solutions vary depending upon the thickness of the polycarbonate film to be etched, as well as the type and thickness of the photoresist chosen. Typical useful concentrations of a suitable salt range in one embodiment from about 30 wt. % to 55 wt. % and in another embodiment from about 40 wt. % to about 50 wt. %. Typical useful concentrations of a suitable solubilizer range in one embodiment from about 10 wt. % to about 35 wt. % and in another embodiment from about 15 wt. % to about 30 wt. %. The use of KOH with a solubilizer is preferred for producing a highly alkaline solution because KOH-containing etchants provide optimally etched features in the shortest amount of time. The etching solution is generally at a temperature of from about 50° C. (122° F.) to about 120° C. (248° F.) preferably from about 70° C. (160° F.) to about 95° C. (200° F.) during etching.

Typically the solubilizer in the etchant solution is an amine compound, preferably an alkanolamine. Solubilizers for etchant solutions according to the present invention may be selected from the group consisting of amines, including ethylene diamine, propylene diamine, ethylamine, methylethylamine, and alkanolamines such as ethanolamine, diethanolamine, propanolamine, and the like. The etchant solution, including the amine solubilizer, according to the present invention works most effectively within the above-referenced percentage ranges. This suggests that there may be a dual mechanism at work for etching polycarbonates or liquid crystal polymers, i.e., the amine acts as a solubilizer for the polycarbonate or liquid crystal polymers most effectively within a limited range of concentrations of alkali metal salt in aqueous solution. Discovery of this most effective range of etchant solutions allows the manufacture of flexible printed circuits based upon polycarbonates or liquid crystal polymers having finely structured features previously unattainable using standard methods of drilling, punching and laser ablation.

Under the conditions of etching, unmasked areas of a dielectric film substrate become soluble by action of the solubilizer in the presence of a sufficiently concentrated aqueous solution of, e.g., an alkali metal salt. The time required for etching depends upon the type and thickness of polycarbonate film to be etched, the composition of the etching solution, the etch temperature, spray pressure, and the desired depth of the etched region.

Materials

The present invention provides an etched dielectric film for use in a hard disc drive flexible circuit. Etching of films to introduce regions of controlled thickness is most effective with films that do not swell in the presence of alkaline etchant solutions. Dielectric films of the present invention may be polycarbonates, liquid crystal polymers, or polyimides, including polyimide copolymers having carboxylic ester units in the polymeric backbone. Preferably, the film being etched is substantially fully cured.

Current continuous roll-to-roll flexible circuit manufacturing processes utilize a base dielectric substrate that is 25 μm thick. However, hard disk drive manufacturers are demanding thinner dielectric layers having a thickness of 15 μm, 12.5 m, 10 μm or less for better flexibility. The thickness of the dielectric film substrate can relate to the level of difficulty associated with flexible circuit processing and manufacture. If the film web is less than about 25 μm thick, problems with material handling can lead to difficulties in consistent manufacture of circuit structures. Unsupported films of uniform thickness less than 25 μm tend to irreversibly stretch or otherwise distort during the multi-step process of printed circuit production. This problem may be overcome using dielectric films according to the present invention in which thinning to less than 25 μm thick occurs after the film has been adhered to a metal substrate such that the metal substrate supports the thinned dielectric allowing it to be processed by continuous roll-to-roll flexible circuit manufacturing process.

Alternatively, applications for highly flexible, dielectric film substrates having thinned regions include suspension structures for hard disk drives. In hard disk drive applications, a flexible circuit can be made from 25 μm film, but the portion of the flexible circuit in the head gimbal assembly area may advantageously have a thickness of 15 μm, 12.5 μm, 10 μm or less for better flexibility.

The existence of controlled depth etching of dielectric materials contributes to improvement in hard disk drive applications. For example, in hard disk drive applications, the main portion of a flexible circuit may be made from 25 μm dielectric film. Reduction in thickness to about 12.5 μm provides a dielectric substrate having reduced stiffness in the head-gimbal assembly region of the circuit. The reduction in stiffness minimizes the influence of the dielectric film on the mechanical attributes of the hard disk drive suspension. Reduction of the influence of the dielectric film leads to less variation in the fly height of the read/write head. This increases signal strength, enabling greater signal area density, which allows for larger memory capacity. Film thinning also facilitates the use of a lower power motor in very power sensitive portable hard drives.

Polyimide

Polyimide film is a commonly used substrate for flexible circuits that fulfill the requirements of complex, cutting-edge electronic assemblies. The film has excellent properties such as thermal stability and low dielectric constant.

As described in U.S. Pat. No. 6,611,046 B1 it is possible to produce chemically etched vias and through holes in flexible polyimide circuits, as needed for electrical interconnection between the circuit and a printed circuit board. Complete removal of polyimide material, for hole formation, is relatively common. Controlled etching without hole formation is very difficult when commonly used polyimide films swell uncontrollably in the presence of conventional etchant solutions. Most commercially available polyimide film comprises monomers of pyromellitic dianhydride (PMDA), or oxydianiline (ODA), or biphenyl dianhydride (BPDA), or phenylene diamine (PPD). Polyimide polymers including one or more of these monomers may be used to produce film products designated under the trade name KAPTON H, K, E films (available from E. I. du Pont de Nemours and Company, Circleville, Ohio) and APICAL AV, NP films (available from Kaneka Corporation, Otsu, Japan). Films of this type swell in the presence of conventional chemical etchants. Swelling changes the thickness of the film and may cause localized delamination of resist. This can lead to loss of control of etched film thickness and irregular shaped features due to etchant migration into the delaminated areas.

In contrast to other known polyimide films there is evidence to show controllable thinning of APICAL HPNF films (available from Kaneka Corporation, Otsu, Japan). The existence of carboxylic ester structural units in the polymeric backbone of non-swelling APICAL HPNF film signifies a difference between this polyimide and other polyimide polymers that are known to swell in contact with alkaline etchants.

APICAL HPNF polyimide film is believed to be a copolymer that derives its ester unit containing structure from polymerizing of monomers including p-phenylene bis(trimellitic acid monoester anhydride). Other ester unit containing polyimide polymers are not known commercially. However, to one of ordinary skill in the art, it would be reasonable to synthesize other ester unit containing polyimide polymers depending upon selection of monomers similar to those used for APICAL HPNF. Such syntheses could expand the range of polyimide polymers for films, which, like APICAL HPNF, may be controllably etched. Materials that may be selected to increase the number of ester containing polyimide polymers include 1,3-diphenol bis(anhydro-trimellitate), 1,4-diphenol bis(anhydro-trimellitate), ethylene glycol bis(anhydro-trimellitate), biphenol bis(anhydro-trimellitate), oxy-diphenol bis(anhydro-trimellitate), bis(4-hydroxyphenyl sulfide) bis(anhydro-trimellitate), bis(4-hydroxybenzophenone) bis(anhydro-trimellitate), bis(4-hydroxyphenyl sulfone) bis(anhydro-trimellitate), bis(hydroxyphenoxybenzene), bis(anhydro-trimellitate), 1,3-diphenol bis(aminobenzoate), 1,4-diphenol bis(aminobenzoate), ethylene glycol bis(aminobenzoate), biphenol bis(aminobenzoate), oxy-diphenol bis(aminobenzoate), bis(4 aminobenzoate) bis(aminobenzoate), and the like.

Polyimide films may be etched using solutions of potassium hydroxide or sodium hydrozide alone, as described in U.S. Pat. No. 6,611,046 B1, or using alkaline etchant containing a solubilizer.

LCP

Liquid crystal polymer (LCP) films represent suitable materials as substrates for flexible circuits having improved high frequency performance, lower dielectric loss, and less moisture absorption than polyimide films. Characteristics of LCP films include electrical insulation, moisture absorption less than 0.5% at saturation, a coefficient of thermal expansion approaching that of the copper used for plated through holes, and a dielectric constant not to exceed 3.5 over the functional frequency range of 1 kHz to 45 GHz. These beneficial properties of liquid crystal polymers were known previously but difficulties with processing prevented application of liquid crystal polymers to complex electronic assemblies. The etchant with solubilizer described herein makes possible the use of LCP film instead of polyimide as an etchable substrate for flex-on-suspension assemblies. A similarity between liquid crystal polymers and APICAL HPNF polyimide is the presence of carboxylic ester units in both types of polymer structures.

Non-swelling films of liquid crystal polymers comprise aromatic polyesters including copolymers containing p-phenyleneterephthalamide such as BIAC film (Japan Gore-Tex Inc., Okayama-Ken, Japan) and copolymers containing p-hydroxybenzoic acid such as LCP CT film (Kuraray Co., Ltd., Okayama, Japan).

Some embodiments of the present invention preferably use a laminated composite in which the dielectric layer is extruded and tentered (biaxially stretched) liquid crystal polymer films. A process development, described in U.S. Pat. No. 4,975,312, provided multiaxially (e.g., biaxially) oriented thermotropic polymer films of commercially available liquid crystal polymers (LCP) identified by the trade names VECTRA (naphthalene based, available from Hoechst Celanese Corp.) and XYDAR (biphenol based, available from Amoco Performance Products). Multiaxially oriented LCP films of this type represent suitable substrates for flexible printed circuits and circuit interconnects suitable for production of device assemblies such as flex-on-suspension assemblies used in hard disk drives.

The development of multiaxially oriented LCP films, while providing a film substrate for flexible circuits and related devices, was subject to limitations in methods for forming and bonding such flexible circuits. An important limitation was the lack of a chemical etching method for use with LCP. Without such a technique, complex circuit structures such as unsupported, cantilevered leads or through holes or vias having angled sidewalls could not be included in a printed circuit design.

Polycarbonate

Polycarbonates also have lower water absorption than polyimide and lower dielectric dissipation, which are very important properties for applications at high frequency (GHz), such as for wireless communication or microwave devices.

While polycarbonate films may be etched using solutions of potassium hydroxide and sodium hydroxide alone, the etch rate is so slow that only the surface of the film can be effectively etch. Etching capabilities to produce flexible printed circuits having thinned polycarbonate substrates or polycarbonate substrates with voids and/or selectively formed indented regions require specific materials and process capabilities not previously disclosed. Until now, low-cost patterning of the polycarbonate film has been a key issue that prevented polycarbonate films from being applied in high volume applications. However, as is disclosed and taught herein, polycarbonates can be readily etched when a solubilizer is combined with highly alkaline aqueous etchant solutions that comprise, for example, water soluble salts of alkali metals and ammonia.

Etching of films to introduce precisely-shaped voids, recesses and other regions of controlled thickness requires the use of a film that does not swell in the presence of alkaline etchant solutions. Swelling changes the thickness of the film and may cause localized delamination of resist. This can lead to loss of control of etched film thickness and irregular shaped features due to etchant migration into the delaminated areas. Controlled etching of films, according to the present invention, is most successful with substantially non-swelling polymers. “Substantially non-swelling” refers to a film that swells by such an insignificant amount when exposed to an alkaline etchant as to not hinder the thickness-reducing action of the etching process. For example, when exposed to some etchant solutions, some polyimide will swell to such an extent that their thickness cannot be effectively controlled in reduction. Examples of suitable non-swelling polycarbonate materials include substituted and unsubstituted polycarbonates; polycarbonate blends such as polycarbonate/aliphatic polyester blends, including the blends available under the tradename XYLEX from GE Plastics, Pittsfield, Mass., polycarbonate/polyethyleneterephthalate(PC/PET) blends, polycarbonate/polybutyleneterephthalate (PC/PBT) blends, and polycarbonate/poly(ethylene 2,6-naphthalate) ((PPC/PBT, PC/PEN) blends, and any other blend of polycarbonate with a thermoplastic resin; and polycarbonate copolymers such as polycarbonate/polyethyleneterephthalate(PC/PET) and polycarbonate/polyetherimide (PC/PEI). Another type of material suitable for use in the present invention is a polycarbonate laminate. Such a laminate may have at least two different polycarbonate layers adjacent to each other or may have at least one polycarbonate layer adjacent to a thermoplastic material layer (e.g., LEXAN GS125DL which is a polycarbonate/polyvinyl fluoride laminate from GE Plastics). Polycarbonate materials may also be filled with carbon black, silica, alumina and the like or they may contain additives such as flame retardants, UV stabilizers, pigment and the like.

Adhesive

Flexures for trace suspension assemblies (TSA) can use a laminated material comprising a metal layer, e.g., stainless steel foil (SST) bonded to a polyimide or polycarbonate polymer film by a bonding adhesive. The polymer film may further be bonded to another metal layer, e.g., a copper (Cu) foil.

Suitable adhesives include thermoplastic adhesive, such as thermoplastic polyimide (TPPI), or other wet chemically etchable adhesive. The adhesive is typically applied in a very thin layer, e.g., in the range of about 0.5 to about 5 μm thick. The adhesive-coated dielectric layer is typically laminated to a stainless steel foil by heating both layers to temperatures typically within 20° C. of each other, but about 30 to 60° C. above the Tg of the adhesive material, then pressing the layers together, using heated opposing platens or rolls, to force the adhesive to flow into the surface texture of the stainless steel. The desired adhesion as measured at room temperature using industry standard 1800 peel adhesion tests needs to be greater than 2 pounds per linear inch (pli).

Non-Adhesive

As alternative to an adhered laminate, composite structures may be used to form a flexure for a hard disk drive. Thermoplastic films, such as liquid crystal polymers and polycarbonate, are suitable for forming a composite structure without the use of an adhesive. Thermoplastic films may be bonded to a supporting metal foil, such as stainless steel, by using an etching solution containing an alkali metal salt and solubilizer to etchant treat a surface of the film. A metal foil having at least one acid treated surface will form a bond to the etchant treated surface upon application of about 100 psi to about 500 psi pressure to the supporting metal foil and the thermoplastic film at temperatures that cause the thermoplastic film to flow. The bonding surface of the metal foil is typically treated with a strongly acidic etch composition. Suitable acidic etchants for stainless steel include corrosive acids such as chromic acid and mixtures of nitric acid and hydrochloric acid.

The second side of the thermoplastic-metal laminate may also be etchant treated so that it may be bonded to a second metal foil. International application WO 00/23987 describes the use of a high temperature laminating press to form a laminate material having a liquid crystal polymer melted for bonding between a stainless steel foil and a copper foil. Such a tri-layer material can be useful for flex-on-suspension (FOS) applications, trace suspension assemblies (TSA), and related disk drive suspension assemblies.

Alternatively, the second side of the thermoplastic-metal laminate may be etchant treated to make the surface suitable for metallization. Such a metallization process may include electroless deposition or vacuum deposition of a seed layer to be augmented with additional metal layers using conventional plating techniques. When using electroless metal plating, the process for producing a metal-seeded thermoplastic-metal laminate may comprise the steps of providing a thermoplastic-metal laminate substrate to which an aqueous solution comprising from about 30 wt % to about 50 wt % of potassium hydroxide and from about 10 wt % to about 35 wt % of s is applied to provide an etched thermoplastic-metal laminate substrate. Applying a tin (II) solution to the etched thermoplastic-metal laminate substrate followed by a palladium (II) solution provides the metal-seeded thermoplastic-metal laminate.

Bond improvement between the thermoplastic-metal laminate and support metal on one side and the metal seeded layer on the other adds to the integrity and durability of a composite structure. The metal-seeded layer further provides the alternative of printed circuit formation using an additive process rather than the subtractive process commonly used for forming electrically conductive traces on carrier substrates.

Circuit-Making Process

In addition to reducing the total thickness of a dielectric polymer film, the etchants disclosed herein can be used to form various features the dielectric films.

The formation of recessed or thinned regions, unsupported leads, through holes and other circuit features in the film typically requires protection of portions of the polymeric film using a mask of a photo-crosslinked negative acting, aqueous processible photoresist or a metal mask. During the etching process the photoresist exhibits substantially no swelling or delamination from the dielectric film.

Negative photoresists suitable for use with dielectric films according to the present invention include negative acting, aqueous developable, photopolymer compositions such as those disclosed in U.S. Pat. Nos. 3,469,982; 3,448,098; 3,867,153; and 3,526,504. Such photoresists include at least a polymer matrix including crosslinkable monomers and a photoinitiator. Polymers typically used in photoresists include copolymers of methyl methacrylate, ethyl acrylate and acrylic acid, copolymers of styrene and maleic anhydride isobutyl ester and the like. Crosslinkable monomers may be multiacrylates such as trimethylol propane triacrylate.

Commercially available aqueous base, e.g., sodium carbonate developable, negative acting photoresists employed according to the present invention include polymethyl-methacrylates photoresist materials such as those available under the trade designation RISTON from E.I. duPont de Nemours and Co., e.g., RISTON 4720. Other useful examples include AP850 available from LeaRonal, Inc., Freeport, N.Y., and PHOTEC HU350 available from Hitachi Chemical Co. Ltd. Dry film photoresist compositions under the tradename AQUA MER are available from MacDermid, Waterbury, Conn. There are several series of AQUA MER photoresists including the “SF” and “CF” series with SF120, SF125, and CF2.0 being representative of these materials.

The dielectric film of the polymer-metal laminate may be chemically etched at several stages in the flexible circuit manufacturing process. Introduction of an etching step early in the production sequence can be used to thin the bulk film or only selected areas of the film while leaving the bulk of the film at its original thickness. Alternatively, thinning of selected areas of the film later in the flexible circuit manufacturing process can have the benefit of introducing other circuit features before altering film thickness. Regardless of when selective substrate thinning occurs in the process, film-handling characteristics remain similar to those associated with the production of conventional flexible circuits.

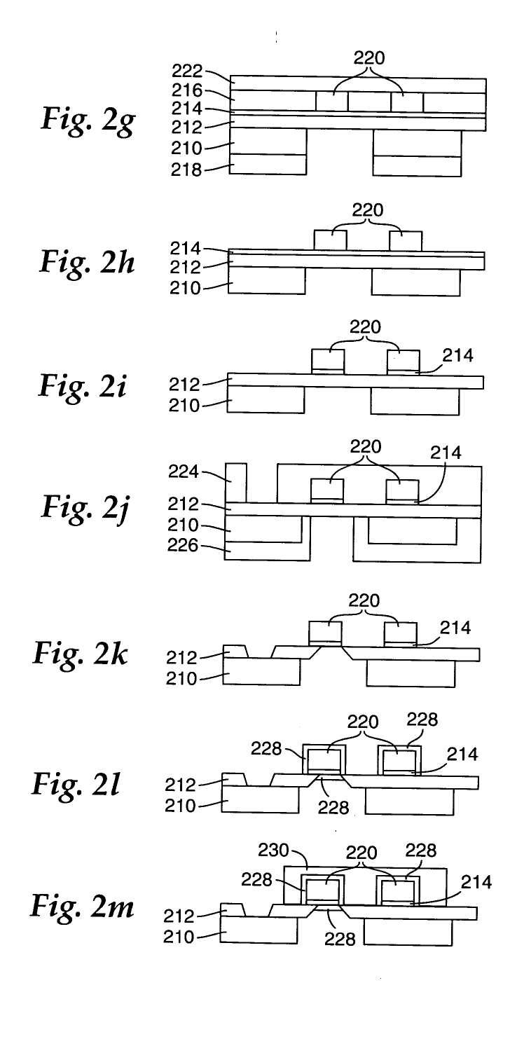

FIGS. 2a-2m illustrate a method for making a fine pitch suspension assembly of the present invention. FIG. 2a shows a metal substrate 210, which is typically stainless steel foil, on which is laminated a layer of dielectric material 212 to form a laminate web structure. The dielectric may be laminated to the metal foil by using an adhesive or by melt-bonding of a thermoplastic dielectric film. If an adhesive is used, a suitable adhesive can be wet chemical etched such as TPPI, available under the trade name PIXEO from Kaneka, Tokyo, Japan. The stainless steel foil is typically 12 μm to 50 μm thick, and in other embodiments 18 μm to 25 μm thick. The dielectric layer is typically about 25 μm to about 75 μm thick. The adhesive thickness is typically about 2 μm to about 5 μm.

The laminate web structure is then passed through an etch bath, which dissolves the dielectric film layer, to form a thinned dielectric layer 212′, as illustrated in FIG. 2b. The etch bath contains an etchant solution suitable for the type of dielectric layer applied to the metal foil, as taught above. The process can provide uniform etching depths in the cross-web and down-web directions. The laminate web is then placed into a sputter chamber where a thin conductive layer is applied to the dielectric surface. The thickness of the sputtered layer is typically about 10 nm to about 200 nm. Typical materials used for this process include, but are not limited to Ni, Cr, and a Ni/Co/Cu metal alloy available under the trade name MONEL from Special Metals Corporation, New Hartford, N.Y., or other materials with high melting points which are suitable for application by sputtering. The web is then placed in a plating bath to build up the conductive layer to a total thickness of about 1 μM to about 5 μM to make it more robust for handling in subsequent processes (and to cause it to act as a low resistance field metal during subsequent electroplating steps). Typical plating materials include copper and nickel. FIG. 2c illustrates the laminate web with metal layer 214. A semi-additive process may then be used to circuitize the laminate web. The surface layer may first cleaned, for example with a solution of potassium peroxymonosulfate, such as that available under the trade name SUREETCH from E.I. du Pont de Nemours, Wilmington, Del. Then layer of photoresist 218, which may be wet or dry, is applied to metal substrate 210 and layer of photoresist 216 is applied to metal layer 214. The photoresist layers are then imaged by exposure to suitable radiation and developed to form circuit patterns as illustrated in FIG. 2d. The photoresist pattern restricts subsequent metal electroplating to specific areas. Typically, the edges of the circuit pattern metal features are well defined by the photoresist, thus making narrow width, narrow pitch, repeatable features possible. To provide close alignment between the trace patterns that will be created on metal layer 214 and the etched features in metal substrate 210, photoresist layers 216 and 218 may be imaged at the same time using aligned phototools. The next step, as illustrated in FIG. 2e is to plate up metal in the circuit pattern on the metal layer 214 to form circuit traces 220. During this process, the metal substrate 210 may be at ground potential or at slightly opposite polarity to the potential of the metal in the plating bath in order to prevents the conductive trace metal from plating onto the metal substrate 210. (Alternatively, metal substrate 210 may be protected by photoresist.) As illustrated in FIG. 2f, another layer of photoresist 222 is then applied over photoresist layer 216 and circuit traces 220. The photoresist is then flood exposed to form an insoluble barrier protect circuit traces 220. Next, as illustrated in FIG. 2g, the portions of metal layer 210 exposed by the pattern of photoresist layer 218 are etched down to thinned dielectric layer 212′. If the metal layer is stainless steel, suitable etchants may include ferric chloride and cupric chloride. Then, as illustrated in FIG. 2h, photoresist layer 222 and the remaining portions of photoresist layers 216 and 218 are removed. Once the photoresist is removed, the underlying surface metal layer 214 and a thin layer of circuit traces 220 are etched away to leave conductive circuit traces 220, as illustrated in FIG. 2i.

The next steps involve creating features in thinned dielectric layer 212′. Initially, photoresist is applied to both sides of the existing structure. Phototools are aligned to the metal patterns on each side of the laminate structure and both layers of photoresist are imaged by exposure to suitable radiation and developed in the same manner as previously described. This results in patterned photoresist layers 224 and 226 aligned to circuit traces 220 and etched metal substrate 210, respectively, as illustrated in FIG. 2j. Next, the exposed portions of dielectric layer 212 are shaped or removed by exposure to, e.g., plasma or chemical etchants, and the remaining portions of photoresist layers 224 and 226 are removed to leave the flexure structure illustrated in FIG. 2k. Suitable methods are known to those skilled in the art. Subsequently, another layer, or layers, of photoresist may be applied, imaged and developed, on one or both sides of the structure to allow circuit traces 220 to be plated with an additional layer of conductive material 228 suitable for electrical bonding or contact compatibility, e.g., gold, as illustrated in FIG. 21. Optionally, as a final step, a layer of covercoat 230 may be applied, exposed and developed to form a protective layer over circuit traces 220, as illustrated in FIG. 2m.

An advantage of this process is that features in both metal substrate 210 and metal layer 214 can be formed anywhere on the structure. This makes it possible to produce “flying” (unsupported by dielectric) features of either electrical traces or structural (e.g., steel) elements. Optionally, dielectric materials compatible with the end product functional requirements may be applied to the flexure structure. The flexure is then ready to be laminated, glued or welded to the load beam of the suspension sub-assembly to make a completed head gimbal assembly for a hard disk drive.

A similar process is the manufacture of flexible circuits comprising the step of etching, which may be used in conjunction with various known pre-etching and post-etching procedures. The sequence of such procedures may be varied as desired for the particular application. A typical additive sequence of steps may be described as follows:

Aqueous processible photoresists are laminated over both sides of a substrate comprising dielectric film with a thin copper side, using standard laminating techniques. Typically, the substrate has a polymeric film layer of from about 25 μm to about 75 μm, with the copper layer being from about 1 to about 5 μm thick.

The thickness of the photoresist is from about 10 μm to about 50 μm. Upon imagewise exposure of both sides of the photoresist to ultraviolet light or the like, through a mask, the exposed portions of the photoresist become insoluble by crosslinking. The resist is then developed, by removal of unexposed polymer with a dilute aqueous solution, e.g., a 0.5-1.5% sodium carbonate solution, until desired patterns are obtained on both sides of the laminate. The copper side of the laminate is then further plated to desired thickness. Chemical etching of the polymer film then proceeds by placing the laminate in a bath of etchant solution, as previously described, at a temperature of from about 50° C. to about 120° C. to etch away portions of the polymer not covered by the crosslinked resist. This exposes certain areas of the original thin copper layer. The resist is then stripped from both sides of the laminate in a 2-5% solution of an alkali metal hydroxide at from about 25° C. to about 80° C., preferably from about 25° C. to about 60° C. Subsequently, exposed portions of the original thin copper layer are etched using an etchant that does not harm the polymer film, e.g., PERMA ETCH, available from Electrochemicals, Inc.

In an alternate substractive process, the aqueous processible photoresists are again laminated onto both sides of a substrate having a polymer film side and a copper side, using standard laminating techniques. The substrate consists of a polymeric film layer about 25 μm to about 75 μm thick with the copper layer being from about 5 μm to about 40 μm thick. The photoresist is then exposed on both sides to ultraviolet light or the like, through a suitable mask, crosslinking the exposed portions of the resist. The image is then developed with a dilute aqueous solution until desired patterns are obtained on both sides of the laminate. The copper layer is then etched to obtain circuitry, and portions of the polymeric layer thus become exposed. An additional layer of aqueous photoresist is then laminated over the first resist on the copper side and crosslinked by flood exposure to a radiation source in order to protect exposed polymeric film surface (on the copper side) from further etching. Areas of the polymeric film (on the film side) not covered by the crosslinked resist are then etched with the etchant solution containing an alkali metal salt and solubilizer at a temperature of from about 70° C. to about 120° C., and the photoresists are then stripped from both sides with a dilute basic solution, as previously described.

It is possible to introduce regions of controlled thickness into the dielectric film of the flexible circuit using controlled chemical etching either before or after the etching of through holes and related voids that completely removes dielectric polymer materials as required to introduce conductive pathways through the circuit film. The step of introducing standard voids in a printed circuit typically occurs about mid-way through the circuit manufacturing process. It is convenient to complete film etching in approximately the same time frame by including one step for etching all the way through the substrate and a second etching step for etching recessed regions of controlled depth. This may be accomplished by suitable use of photoresist, crosslinked to a selected pattern by exposure to ultraviolet radiation. Upon development, removal of photoresist reveals areas of dielectric film that will be etched to introduce recessed regions.

Alternatively, recessed regions may be introduced into the polymer film as an additional step after completing other features of the flexible circuit. The additional step requires lamination of photoresist to both sides of the flexible circuit followed by exposure to crosslink the photoresist according to a selected pattern. Development of the photoresist, using the dilute solution of alkali metal carbonate described previously, exposes areas of the dielectric film that will be etched to controlled depths to produce indentations and associated thinned regions of film. After allowing sufficient time to etch recesses of desired depth into the dielectric substrate of the flexible circuit, the protective crosslinked photoresist is stripped as before, and the resulting circuit, including selectively thinned regions, is rinsed clean.

The process steps described above may be conducted as a batch process using individual steps or in automated fashion using equipment designed to transport a web material through the process sequence from a supply roll to a wind-up roll, which collects mass produced circuits that include selectively thinned regions and indentations of controlled depth in the polymer film. Automated processing uses a web handling device that has a variety of processing stations for applying, exposing and developing photoresist coatings, as well as etching and plating the metallic parts and etching the polymer film of the starting metal to polymer laminate. Etching stations include a number of spray bars with jet nozzles that spray etchant on the moving web to etch those parts of the web not protected by crosslinked photoresist.

To create finished products such as flexible circuits, interconnect bonding tape for “TAB” (tape automated bonding) processes, microflex circuits, and the like, conventional processing may be used to add multiple layers and plate areas of copper with gold, tin, or nickel for subsequent soldering procedures and the like as required for reliable device interconnection.

### EXAMPLES

### Examples 1-4

Materials

Dielectric Film Substrates

A. BIAC film—Liquid crystal polymer (LCP) film 25 μm thick is produced by Japan Gore-Tex Inc., Okayama-Ken, Japan

B. APICAL HPNF—film (50 micron film) is produced by Kaneka Corporation, Otsu, Japan

Etchant Compositions

AA. 33 wt % potassium hydroxide+19 wt % ethanolamine+48 wt % de-ionized water.

BB. 45 wt % potassium hydroxide+55 wt % de-ionized water.

CC. 35 wt % potassium hydroxide+15 wt % ethanolamine+50 wt % de-ionized water.

Photoresist

A dry film photoresist was used for selective location of regions for controlled etching. The photoresist material is available from MacDermid Inc. of Waterbury, Conn. under product numbers SF 310, SF 315 or SF 320.

Table 1 provides evidence that 25 μm liquid crystal polymer film and 50 μm polyimide film comprising a polymer derived from p-phenylene bis(trimellitic acid monoester anhydride) monomer can be handled using conventional automated equipment for producing flexible circuits. During the flexible circuit production process, the etchants indicated in the table were sprayed automatically for controlled thinning of regions of film that were exposed by selective removal of photoresist. This produced recessed areas having a film thickness that was reduced to 25% to 50% of the original film thickness.

TABLE 1
Polyimide and Liquid Crystal Polymer

| | Ex. 1 | Ex. 2 | Ex. 3 | Ex. 4 |
|---|---|---|---|---|
| Film | A | B | B | B |
| Etchant | AA | BB | CC | BB |
| Temperature | 71° C. | 93° C. | 82° C. | 88° C. |
| Line Speed | 38 cm/min | 41 cm/min | 102 cm/min | 75 cm/min |
| Thickness After | 12.5 μm | 12.0 μm | 11.0 μm | 21.6 μm |
| Etching | | | | |

The partial thinning method of the present invention can be very precise. For example, Ex. 4 was a laminate of stainless steel and 50 mm APICAL HPNF film was etched with a 45 wt. % KOH etchant to reduce its overall thickness. The film experienced a dwell time of about 1.5 minutes. The resulting material had an average thickness reduction to 21.63 μm with a standard deviation of 0.85 μm. The standard deviation of the roughness of the original APICAL HPNF film was 0.65 μm showing that the etching process was uniform across and down the web with a minimal effect on the surface roughness of the finished laminate web.

### Examples 5-9 and Comparative Example C1

For this series of examples, different etchant solutions were used to etch different types of polycarbonate films. The aqueous processible photoresists are laminated over both sides of a substrate having a polymeric film side using standard laminating techniques. Upon imagewise exposure of both sides of the photoresist to ultraviolet light or the like, through a mask, the exposed portions of the photoresist become insoluble by crosslinking. The resist is then developed, by removal of unexposed polymer with a dilute aqueous solution, e.g., a 0.5-1.5% sodium carbonate solution, until desired patterns are obtained on both sides of the laminate.

For Examples 5, 7-9 and C1, the films were subjected to two-sided etching. In other words, no coatings or resists were applied to either side of the film, so that both sides were exposed to the etchant. To determine etching speed determination, a small film sample (about 1 cm× about 1 cm) was cut and immersed in an etchant solution. This resulted in the sample film being etched on both sides. Etching speed (for two one sides) was then determined by dividing in half the reduced thickness over by the etching time.

For Example 6, the films were subjected to one-sided etching. A dry aqueous processible photoresists was laminated over both sides of the polycarbonate film materials. One side of the resist was flood-exposed and the other side was exposed under a patterned mask. The exposed portions of the photoresist became insoluble by crosslinking. The resist was then developed by removal of the unexposed polymer with a dilute aqueous 0.5-1.5% sodium carbonate solution, resulting in a polycarbonate film with a solid layer of resist on one side and a patterned layer of resist on the other side. The speeds for etching a single side of a sample are shown below in Table 3. For single-side etching, e.g., when covering one side with photoresist, the etching speed would be half of the speed of the two-side etching. For polycarbonate films with resists, one side of the resist (2 mil thick) was flood-exposed first and the other side is exposed under a mask and then developed. All etching experiments were carried out in a beaker, without stirring, using a water bath at 85° C. unless specifically noted otherwise. The etching results for polycarbonate films are summarized in Table 3. The etchant compositions are shown in Table 3 as the ratio of KOH to solubilizer (ethanolamine) with the balance of the composition being water unless otherwise specified. For example, Ex. 5 shows ‘45/20’ in the etchant column, which indicates an etchant composition of 45 wt. % of KOH, 20 wt. % of ethanolamine, and the remainder is water. The designations of “A” through “I” correspond to the polycarbonate films designated as A through I in Table 2 below.

TABLE 2
Polycarbonate Films

| Material | | | Film | |
|---|---|---|---|---|
| trade name | | Chemical composition | Thickness | Available from |
| A1 | LEXAN | Polycarbonate | 132 μm | GE Plastics |
| | T2F DD 112 | (Smooth/matte finish) | | (Pittsfield Ma) |
| A2 | LEXAN | Polycarbonate | 260 μm | GE Plastics |
| | T2F DD 112 | (Smooth/matte finish) | | |
| B | LEXAN | Polycarbonate | 254 μm | GE Plastics |
| | T2F OQ 112 | (optically clear) | | |
| C | LEXAN | Polycarbonate with | 128 μm | GE Plastics |
| | FR83 116 | flame retardant | | |
| D | XYLEX | PC and aliphatic | 125 μm | GE Plastics |
| | D7010MC | polyester blends | | |
| E | XYLEX | PC and aliphatic | 165 μm | GE Plastics |
| | D5010MC | polyester blends | | |
| F | XYLEX | PC and aliphatic | 164 μm | GE Plastics |
| | D56 | polyester blends | | |
| G | LEXAN | Polycarbonate | 265 μm | GE Plastics |
| | 8B25 | (filled with carbon | | |
| | | black) | | |
| H | Zelux | Polycarbonate | 50 μm | Westlake Plastics |
| | Natural film | (Smooth/fine matte | | Company |
| | | finish) | | (Lenni, PA) |
| I | Makrofol | Polycarbonate | 150 μm | Bayer Plastics |
| | DPF 5014 | (velvet/very fine matte | | Div. |
| | | finish) | | (Pittsburgh, PA) |

TABLE 3
Summary of polycarbonate (PC) etching results

| | | Polyimide Film Type | | | | | | | | | |
|---|---|---|---|---|---|---|---|---|---|---|---|
| | | A1 | A2 | B | C | D | E | F | G | H | I |
| Ex. | Etchant | Single side etching speed (μm/min) | | | | | | | | | |
| 5 | 45/20 | 23.0 | — | 20 | 15.3 | 11.0 | 2.0 | 1.2 | — | — | — |
| 6 | 42/21*^{†} | — | 26.0 | — | — | — | — | — | — | 14.7 | 19 |
| 7 | 40/20 | 15.6 | — | 14.1 | 9.0 | 7.1 | 1.3 | 1.2 | 17.0 | — | 11.9 |
| 8 | 36/28 | 15.0 | — | 14.8 | 10.0 | 7.9 | 1.6 | 1.5 | — | — | — |
| 9 | 33/33 | 11.5 | — | 11.1 | 7.6 | 5.0 | 1.8 | 1.7 | — | — | — |
| C1 | 45/0 | 2.5 | — | 2.8 | 1.2 | 1.0 | 0.2 | 0.034 | — | — | — |

*Etch temperature was about 92° C.
^{†}Titration results showed an actual concentration of 41.8 wt % KOH and 20.9 wt % ethanolamine.

It will be appreciated by those of skill in the art that, in light of the present disclosure, changes may be made to the embodiments disclosed herein without departing from the spirit and scope of the present invention.

What is claimed is:

1. An article comprising:
a flexure assembly of a hard disk drive comprising a metal substrate and a dielectric film attached to said metal substrate, said dielectric film comprising a polymer selected from the group consisting of polyimides, liquid crystal polymers, and polycarbonates, wherein said dielectric film has been etched to a thickness of less than about 20 μm from an original thickness of about 25 μm or greater.

2. An article according to claim 1 wherein the dielectric film is a polyimide having a carboxylic ester structural units in the polymer backbone.

3. An article according to claim 1 wherein the dielectric film is attached to the metal substrate by an adhesive layer.

4. An article according to claim 1 wherein the dielectric film is a liquid crystal polymer attached to the metal substrate without an adhesive layer.

5. An article according to claim 1 wherein the dielectric film has been etched to a thickness of less than about 10 μm.

6. An article according to claim 1 further comprising a patterned conductive layer on the dielectric layer.

7. An article according to claim 1 including at least one unsupported cantilevered lead.

8. A method comprising
providing a metal substrate,
attaching a dielectric film to said metal substrate, said dielectric film comprising a polymer selected from the group consisting of polyimides, liquid crystal polymers, and polycarbonates, said film having a thickness of about 25 μm or greater, etching said dielectric film to a thickness of less than about 20 μm.

9. A method according to claim 8 wherein the dielectric film is a polyimide having a carboxylic ester structural unit in the polymer backbone.

10. A method according to claim 8 wherein the dielectric film is attached to the metal substrate by an adhesive layer.

11. A method according to claim 8 wherein the dielectric film is a liquid crystal polymer attached to the metal substrate without an adhesive layer.

12. A method according to claim 10 wherein the dielectric film has been etched to a thickness of less than about 10 μm.

13. A method according to claim 8 wherein the dielectric film is etched with an aqueous solution comprising
about 30 wt. % to about 55 wt. % of an alkali metal salt; and
about 10 wt. % to about 35 wt. % of a solubilizer dissolved in said solution.

14. A process according to claim 8 wherein said alkali metal salt is selected from the group consisting of sodium hydroxide and potassium hydroxide.

15. A process according to claim 8 wherein said solubilizer is an amine.

16. A process according to claim 8 wherein said solubilizer is ethanolamine.

17. A method according to claim 8 wherein the etching is carried out at a temperature of about 50° C. to about 120° C.
